(19) United States
(12) Patent Application Publication
(10) Pub. No.: US 2026/0187906 A1
(43) Pub. Date: Jul. 2, 2026

(54) METHOD FOR GENERATING A SIMULATED BIDIMENSIONAL IMAGE OF A PORTION OF A PATIENT'S BODY

(71) Applicant: AVATAR MEDICAL, Paris (FR)

(72) Inventors: Mohamed EL BEHEIRY, Paris (FR); Elodie BRIENT-LITZLER, Paris (FR); Jean-Luc DEGRENAND, Paris (FR); Xavier WARTELLE, Paris (FR)

(73) Assignee: AVATAR MEDICAL, Paris (FR)

(21) Appl. No.: 19/131,990

(22) PCT Filed: Nov. 24, 2023
(86) PCT No.: PCT/EP2023/083020

§ 371 Date: May 22, 2025

Related U.S. Application Data
(60) Provisional application No. 63/427,976, filed on Nov. 25, 2022.

(51) Int. Cl. G06T 15/08; G06T 15/06

(52) U.S. Cl. CPC G06T 15/08; G06T 15/06; G06T 2200/24; G06T 2210/41

(57) ABSTRACT

The present invention relates to a method for generating a simulated bidimensional image of a portion of a patient's body so as to help the planning of a medical intervention on said patient.

### FIELD OF INVENTION

The present invention relates to the field of image synthesis, and more specifically to a computer implemented method for generating a simulated bidimensional image of a portion of a patient's body so as to help the planning of a medical intervention on the patient.

### BACKGROUND OF INVENTION

In the context of interventional procedures and surgeries, doctors use medical imaging data for diagnostics, or in order to monitor actions during the intervention or to evaluate the success of the procedure. For example, interventional radiology combines a radiological imaging technique (using X-rays) with an invasive procedure for diagnostic and/or therapeutic purposes. Considering the other example of orthopedic surgery, post-operative imaging often helps in assessing the surgical outcome. Minimally invasive surgeries can also involve imaging devices placed in the body of patients which generate 2D images, such as endoscopes, which can be based on various modalities (standard photography, fluorescence, spectroscopy . . . ).

There is margin for improvement notably in the pre-operative (preop) phase of planification of such interventional procedures. The present invention aims at providing a solution in this regard.

### SUMMARY

The present disclosure relates to a computer-implemented method for generating a simulated bidimensional image of a portion of a patient's body so as to help the planning of a medical intervention on said patient, by means of a graphical user interface comprising a controller configured to control the interaction between a user and the graphical user interface, said medical intervention requiring an acquisition of an effective bidimensional image during or after said medical intervention, said method comprising:
receiving real three-dimensional medical images of said portion of the patient's body,
reconstructing a tridimensional digital model of said portion of the patient's body based on said real three-dimensional medical images, the reconstructed tridimensional digital model being referred to as body 3D model,
displaying in the graphical user interface a three-dimensional scene comprising said body 3D model by means of a ray tracing algorithm, wherein the three-dimensional scene has a corresponding scene coordinate system attached thereto,
computing angular coordinates based on a current position of the controller in a predetermined user coordinate system, said angular coordinates representing a visualization direction in the scene coordinate system,
generating said simulated bidimensional image based on the body 3D model and said angular coordinates by means of another ray tracing algorithm.

In what follows the expression bidimensional image will be replaced by the expression 2D image and the term “3D” is meant to replace the expression “three-dimensional”.

The real 3D medical images of the patient body can be acquired by any 3D imaging modalities including but not limited to: X-ray (Computed Tomography (CT)-scans, Cone Beam Computed Tomography (CBCT) scan), Magnetic Resonance (MR) or Ultrasound.

Thanks to the present method, it is possible to generate a plurality of simulated 2D images by manipulating the controller and exploring at wish different point of views and visualization directions. It is thus possible to envisage and select a specific view point and visualization direction. 2D images can typically be radiography 2D images (using X-rays). They can also be 2D images generated by the camera of an endoscope, with or without magnification.

According to some embodiments, the method further comprises a step of displaying in a 2D window of the graphical user interface said simulated 2D image. This displaying step helps the user assessing the content of the generated simulated 2D image.

According to some embodiments, the method further comprises, when a visualization criterion is met, recording effective angular coordinates into an external memory, the effective angular coordinates being either equal to the angular coordinates or representative of an orientation, with respect to an interventional coordinate system, of an acquisition device configured to acquire the effective 2D image. For example, when the visibility of the portion of the patient's body on the simulated 2D image is satisfying, it can be concluded that the corresponding visualization direction is suitable for the medical intervention purposes.

According to some embodiments, the acquisition of the effective 2D image is performed during the medical intervention with an interventional 2D imaging device. Thanks to the exploration of visualization directions and the generation of a plurality of simulated 2D images, it is possible to predict ahead of time a configuration, notably a geometric configuration, of the interventional 2D imaging device to acquire an effective 2D image during the medical intervention.

In an example, the effective 2D image is a 2D radiographic image acquired by means of X rays and the interventional radiographic imaging device is a C-arm or G-arm.

Another aspect of the present disclosure pertains to a use of effective angular coordinates recorded with the method according to the previous embodiments for positioning a C-arm or G-arm during a medical intervention.

Another aspect of the present disclosure pertains to a use of a simulated 2D image generated with the method according to the previous embodiments for planning an implant position in the portion of the patient's body. The simulated 2D image might give an insight on the structure of the portion of the patient's body that is not given by radiology images acquired in a traditional manner and helps for decision on how the place the implant.

In another example, the 2D image is a photograph of the inside of a patient and the interventional imaging device is an endoscope.

According to some embodiments, the ray tracing algorithm generating the 2D image is performed by modeling rays of light all parallel to the visualization direction as determined by the position of the controller.

According to some embodiments, the ray tracing algorithm generating the 2D image is performed by modeling rays of light mimicking acquisition characteristics of an imaging device aligned in the visualization direction, such as the use of specific lenses, filters, collimators.

According to some embodiments, the ray tracing algorithm generating the 2D image can be configured to render a minimal intensity projection, a maximal intensity projection, or an average intensity projection.

According to an alternative, the present disclosure relates to a computer-implemented method for generating a simulated 2D image of a portion of a patient's body so as to help the planning of a medical intervention on said patient, by means of a graphical user interface comprising a controller configured to control the interaction between a user and the graphical user interface, said medical intervention requiring an acquisition of an effective 2D image during or after said medical intervention, said method comprising:
receiving real 3D medical images of said portion of the patient's body, said real 3D medical images being composed of voxels,
computing a tridimensional digital model of said portion of the patient's body based on said real 3D medical images, by means of a ray tracing algorithm, the reconstructed tridimensional digital model being referred to as body 3D model,
displaying in the graphical user interface a three-dimensional scene comprising said body 3D model computed by means of said ray tracing algorithm, wherein the three-dimensional scene has a corresponding scene coordinate system attached thereto,
computing angular coordinates based on a received position and a received orientation in the scene coordinate system of a selected device, said angular coordinates representing a visualization direction in the scene coordinate system,
generating said simulated 2D image based on said computed angular coordinates by means of a ray-based algorithm comprising a step of sampling the real 3D medical images'voxels along rays whose trajectories depend on said computed angular coordinates,
displaying in a 2D window of the graphical user interface said simulated 2D image.

According to other advantageous aspects of the invention, the method includes one or more of the following features, taken alone or in any technically possible combination:
the received position and the received orientation of the selected device are one of:
   a current position and orientation of the controller in a predetermined user coordinate system; or
   a selected position and selected orientation of a virtual device, said virtual device being previously selected by a user and displayed in said 3D scene with said selected position and said selected orientation;
the method further comprises displaying the simulated 2D image in a display plane positioned in the 3D scene depending on selected position and selected orientation, the display plane's coordinates changing in the 3D scene in real time, as the user moves the virtual device or the controller in the 3D scene;
the 3D body model, and the 2D simulated image displayed in its specific moving display plane, are displayed together in the 3D scene using a stereoscopic display such as a virtual reality headset, so as to ease the spatial cognition of the user in relating the content of the simulated 2D image to the representation of the body 3D model;
the effective 2D image is one of:
   a radiographic 2D image acquired by means of X rays;
   an ultrasound 2D image acquired by means of a sonography device; or
   an image acquired by a camera placed inside the patient's body;
the real 3D medical images are Computed Tomography (CT) scans, Magnetic Resonance (MR) images or 3D ultrasound images;
the method further comprises, when a visualization criterion is met, recording effective angular coordinates into an external memory, the effective angular coordinates being either equal to the angular coordinates or representative of an orientation, with respect to an interventional coordinate system, of an acquisition device configured to acquire the effective 2D image;
the acquisition of the effective 2D image is performed during the medical intervention with an interventional 2D imaging device;
the interventional 2D imaging device is one of: a C-arm, a G-arm, an endoscope, or a sonography device;
the ray-based algorithm generating the simulated 2D image is performed using rays all parallel to the visualization direction as determined by the current position and the current orientation of the controller;
the ray-based algorithm generating the simulated 2D image is performed by modeling rays having a predetermined pattern, said predetermined pattern being positioned in the 3D scene using said selected position and selected orientation, and being based on physical characteristics of a real 2D imaging system, possibly comprising specific lenses, filters or collimators, and wherein the rays used by the ray-based algorithms propagates in the scene according to the physics of said real 2D imaging system;
the ray-based algorithm generating the simulated 2D image can be configured to render a minimal intensity projection, a maximal intensity projection, or an average intensity projection; and/or
the ray-based algorithm generating the simulated 2D image is a ray tracing algorithm.

In the same manner, another aspect of the present disclosure pertains to:
a use of effective angular coordinates recorded with the method according to the previous embodiments for positioning a C-arm or G-arm during a medical intervention;
a use of a simulated 2D image generated with the method according to the previous embodiments for planning an implant position in the portion of the patient's body. The simulated 2D image might give an insight on the structure of the portion of the patient's body that is not given by radiology images acquired in a traditional manner and helps for decision on how the place the implant.

Another aspect of the present disclosure pertains to a device comprising a processor, a graphical user interface comprising a controller configured to control the interaction between a user and the graphical user interface, said processor being configured to carry out the method according to the any of the previous embodiments and alternatives described above.

Another aspect of the present disclosure pertains to a computer program product comprising instructions which, when the program is executed by a computer, cause the computer to carry out the method according to the previous embodiments.

In addition, the disclosure relates to a computer program comprising software code adapted to perform a method for predicting or a method for training compliant with any of the above execution modes when the program is executed by a processor.

The present disclosure further pertains to a non-transitory program storage device, readable by a computer, tangibly embodying a program of instructions executable by the computer to perform a method for predicting or a method for training, compliant with the present disclosure.

Such a non-transitory program storage device can be, without limitation, an electronic, magnetic, optical, electromagnetic, infrared, or semiconductor device, or any suitable combination of the foregoing. It is to be appreciated that the following, while providing more specific examples, is merely an illustrative and not exhaustive listing as readily appreciated by one of ordinary skill in the art: a portable computer diskette, a hard disk, a ROM, an EPROM (Erasable Programmable ROM) or a Flash memory, a portable CD-ROM (Compact-Disc ROM).

### DEFINITIONS

In the present invention, the following terms have the following meanings:

The terms “adapted” and “configured” are used in the present disclosure as broadly encompassing initial configuration, later adaptation or complementation of the present device, or any combination thereof alike, whether effected through material or software means (including firmware).

The term “processor” should not be construed to be restricted to hardware capable of executing software, and refers in a general way to a processing device, which can for example include a computer, a microprocessor, an integrated circuit, or a programmable logic device (PLD). The processor may also encompass one or more Graphics Processing Units (GPU), whether exploited for computer graphics and image processing or other functions. Additionally, the instructions and/or data enabling to perform associated and/or resulting functionalities may be stored on any processor-readable medium such as, e.g., an integrated circuit, a hard disk, a CD (Compact Disc), an optical disc such as a DVD (Digital Versatile Disc), a RAM (Random-Access Memory) or a ROM (Read-Only Memory). Instructions may be notably stored in hardware, software, firmware or in any combination thereof.

### BRIEF DESCRIPTION OF THE DRAWINGS

The present disclosure will be better understood, and other specific features and advantages will emerge upon reading the following description of particular and non-restrictive illustrative embodiments, the description making reference to the annexed drawings wherein:

FIG. 1 represents a schematic representation of an embodiment of a computer-implemented method for generating a simulated 2D image of a portion of a patient's body.

FIG. 2A is a real example of a three-dimensional scene displayed on a graphical user interface representing a tridimensional digital model of a portion of a patient's body together with a two-dimensional window comprising a simulated radiographic image of the portion of the patient's body. FIG. 2B is the schematic representation of the real example shown in FIG. 2A.

FIG. 3A represents a second example of a three-dimensional scene displayed on a graphical user interface representing a tridimensional digital model of a portion of a patient's body together with a two-dimensional window comprising a simulated radiographic image of the portion of the patient's body. FIG. 3B is the schematic representation of the real example shown in FIG. 3A.

FIG. 4A represents a third example of a three-dimensional scene displayed on a graphical user interface representing a tridimensional digital model of a portion of a patient's body together with a two-dimensional window comprising a simulated radiographic image of the portion of the patient's body. FIG. 4B is the schematic representation of the real example shown in FIG. 4A.

### ILLUSTRATIVE EMBODIMENTS

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein may represent conceptual views of illustrative circuitry embodying the principles of the disclosure. Similarly, it will be appreciated that any flow charts, flow diagrams, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, a single shared processor, or a plurality of individual processors, some of which may be shared.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

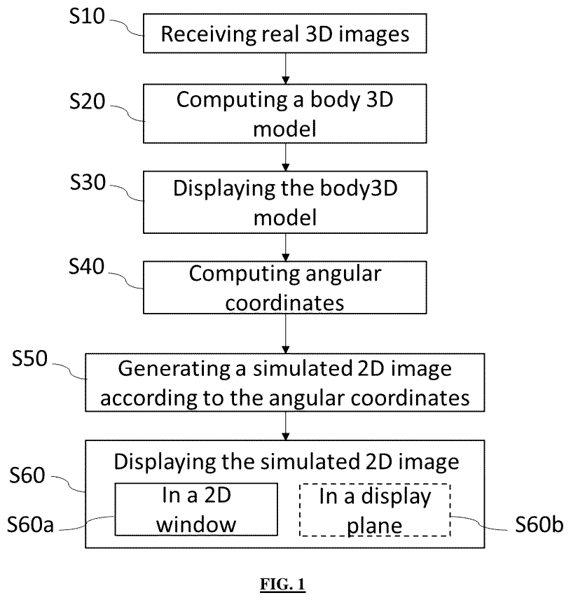

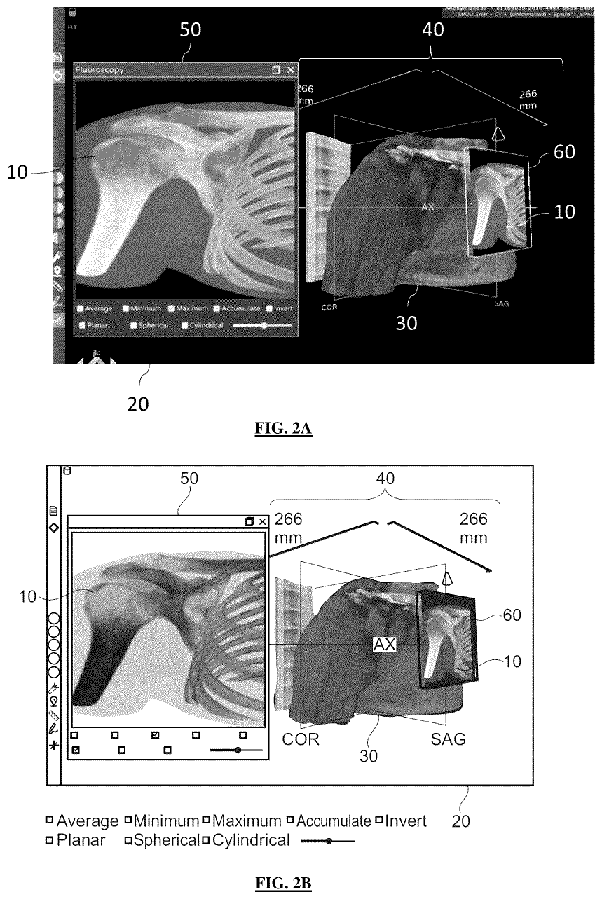

As illustrated in FIG. 1, the method for generating a simulated 2D image (10) of a portion of a patient's body comprises three main steps:
Step S10: receiving real 3D images;
Step S20: computing a body 3D model (30)
Step S30: displaying the body 3D model (30)
Step S40: computing angular coordinates
Step S50: generating the simulated 2D image (10) according to the computed angular coordinates
Step S60: displaying the simulated 2D image (10).

Each of these steps will now be described in detail:
Step S10: Receiving Real 3D Images

This step consists in receiving real 3D images of a portion of a patient's body in view of preparing a surgery or any medical intervention required for the health of the patient. The real 3D image may be Computed Tomography (CT) scans, Magnetic Resonance (MR) images or 3D ultrasound images.
Step S20: Computing a Body 3D Model (30)

This step consists in computing a tridimensional digital model (30) (referred to as “body 3D model”) of the portion of the patient's body that requires the medical intervention and based on the real 3D medical images received (S20).

In order to have the most realistic and precise representation a ray tracing algorithm is used, such as, for example but not limited to: ray casting, recursive ray tracing, distribution ray tracing, photon mapping and/or path tracing.

Ray tracing algorithms are capable of simulating a variety of optical effects offering a realistic, pleasant and comfortable view of the patient's anatomy thereby modeled in 3D, with realistic lighting, a global illumination, accurate reflections and refractions, soft shadows, details in textures and consistency. Such a quality body 3D model improves the analysis of the medical situation, the diagnostic and the medical care of the patient.

Regarding the principle of the ray tracing algorithm and such ray-based volume rendering methods algorithms:
Rays casting involves propagating rays from the position of the observer (e.g. the surgeon or the medical staff member preparing the patient treatment) through a proxy geometry that maps to medical image data. As rays advance inside the volume, the medical image data is sampled accordingly and color and opacity (determined by the transfer function) is blended through compositing. The final accumulated composition is displayed to the image plane. Ray tracing can also permit secondary rays to be recursively traced from an initial ray to simulate scattering. Meaning, a secondary ray can be generated and propagated from the initial ray's point of interaction in the medical image data. This type of ray behavior allows for the simulation of optical effects such as ambient occlusion, subsurface scattering, global illumination and skybox reflections.
Step S30: Displaying the Body 3D Model

This step consists in displaying in a graphical user interface (20) a three-dimensional—3D—scene (40) comprising the body 3D model (30) computed by means of the ray tracing algorithm. The 3D scene (40) has a corresponding scene coordinate system attached thereto.

Advantageously, a stereoscopic display is used, such as a virtual reality headset. This enables to ease the spatial cognition of the users, here the surgeons or the medical staff members who are generally not accustom to use 3D imaging in there day to day practice.
Step S40: Computing Angular Coordinates

This step consists in computing angular coordinates based on a received position and a received orientation in the scene coordinate system of a selected device (S40), these angular coordinates representing a visualization direction in the scene coordinate system.

When the user uses a controller configured to navigate in the graphical user interface (20) (i.e., that the controller is configured to control interaction between a user and the graphical user interface), the received position and the received orientation are the current position and orientation of the controller in a predetermined user coordinate system (i.e., the selected device corresponds to the controller).

Advantageously, when the user wants to obtain a simulated 2D image coming from a virtual device, such as a medical imaging device, the received position and the received orientation may be a selected position and selected orientation of the virtual device (i.e., the selected device corresponds to the virtual device). These selected position and orientation correspond to the position and the orientation of the virtual device at the coordinates where the user previously placed the virtual device with the controller in the 3D scene (40). The simultaneous display of the virtual device and the body 3D model in the 3D scene can be obtained by techniques such as hybrid rendering where 3D object files representing the virtual device (for example, as a surface-based polygonal mesh) are rendered together with the body 3D model obtained through the ray tracing algorithm.

Advantageously, the virtual device is selected in a list of virtual devices comprising: radiographic devices such as C-arm or G-arm, endoscopes, or sonography devices for example.
Step S50: Generating a Simulated 2D Image (10) According to the Computed Angular Coordinates

This step consists in generating the simulated 2D image (10) based on the computed angular coordinates. A ray-based algorithm is used to generate the simulated 2D image. Particularly, the ray-based algorithm comprises a step of sampling the real 3D medical images'voxels along rays whose trajectories depend on said angular coordinates. The characteristics, typically including intensity values, of the sampled voxels are used as inputs for the ray-based algorithm. Several types of ray-based algorithms can be applied

Advantageously, the ray-based algorithm can calculate and display any arbitrary statistical measure of the sampled voxel intensity values along the ray (e.g.: average, maximum, minimum, accumulation, standard deviation). Depending on the nature of the tissues present in the anatomic portion simulated in the simulated 2D image, it is advantageous for the user to select which ray-based algorithm to use so that particular details like specific tissues or structures (e.g.: bones, ligaments, muscles . . . ) stand out in the simulated 2D image.

Advantageously, the ray-based algorithm can be another ray tracing algorithm, involving another transfer function than the one used to display the body 3D model.

The ray-based algorithm can also involve classifiers, where each sampled voxel will be associated to a specific class and where this classification impacts the operations realized by the algorithm. The classifiers can be based on machine learning. For instance, the classifiers can identify the voxels of anatomical structures of interest.

Specific transfer functions can be optimized so as to create a simulated 2D image that would match at best the real corresponding 2D image (radiography, photography generated by the camera of an endoscope . . . ). This optimization of the specific transfer functions and/or color maps can be based on machine learning.

Several orientations of the rays can be applied:
Rays can be all parallel to the viewing direction.
Rays can be modeled as coming from a single point source, the display plane being located between the point source and the 3D body model in the scene.
Rays can map a specific geometrical pattern, for instance a sphere or a cylinder. In such cases the ray-based algorithm can realize a spherical or cylindrical projection.
Rays can map a more complex pattern mimicking the diffusion of the radiations, light or ultrasound coming from a specific acquisition device.
Step S60: Displaying the Simulated 2D Image

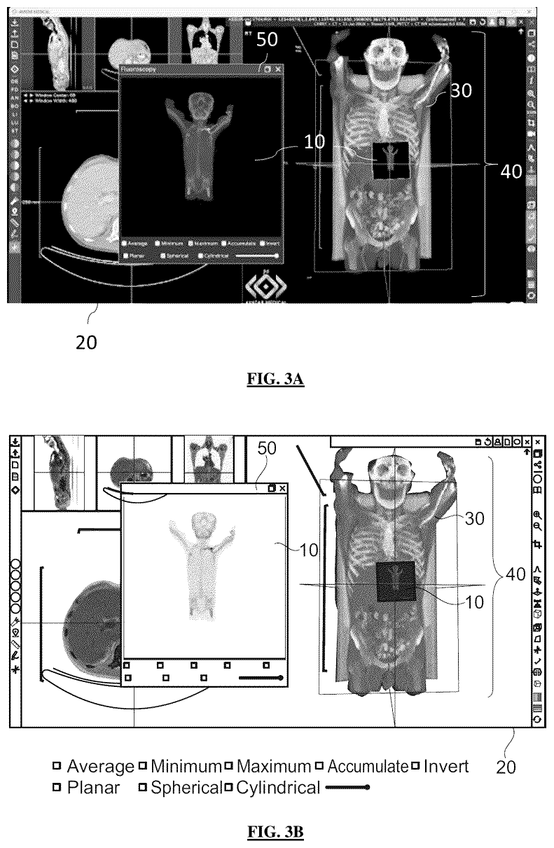

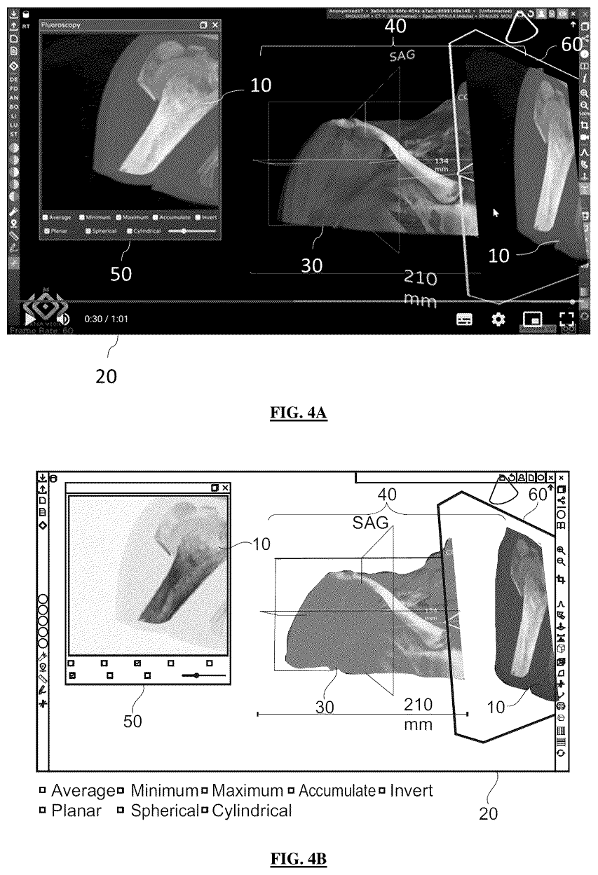

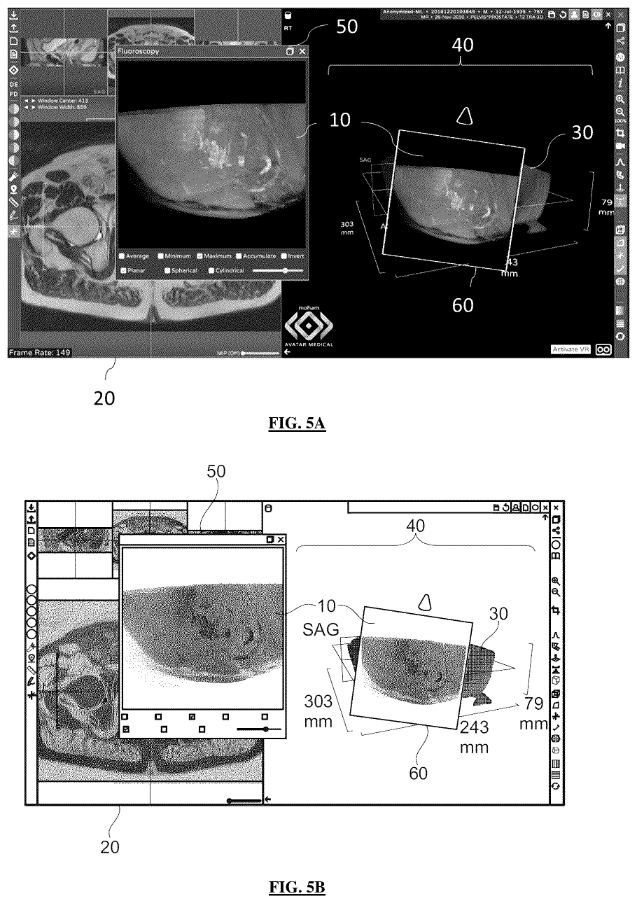

As shown in FIGS. 2 to 5, the simulated 2D image can be displayed in two manners:
in a 2D window (50) of the graphical user interface (20); and/or
in a display plane (60) positioned in the 3D scene (40) depending on received position and received orientation (S60b), the display plane's coordinates changing in the 3D scene (40) in real time, as the user moves the virtual device or the controller in the 3D scene (40).

When the display is made by a stereoscopic display such as a virtual reality headset, it facilitates the vision of the user which keeps in foreground the simulated 2D image (10) obtained at the received position and received orientation, while still seeing the 3D body model behind in the same field of view. This is especially useful since the simulated 2D image (10) is updated in real time in the window when the user modifies and adjusts precisely the received position and received orientation (i.e., the position and orientation of the controller or of the virtual device) in the 3D scene displayed in background with the body 3D model (30).

### CONCLUSION

The present invention offers many advantages. It helps surgeons and any medical staff member to bridge the gap between the real world in 3D of their patients'anatomy, and the 2D images that can be acquired by different medical imaging systems.

For example, they can simulate which of these medical imaging systems is the most suitable for the medical intervention they planned to do and, during the medical intervention they will be able to accurately positioned the medical system selected. When using Xray systems, this will considerably reduce the Xray doses received by the patient and the medical staff present during the medical intervention.

Such invention can be helpful in preop (for planning and selecting the best elements required like the most suitable implant, the most suitable medical imaging system to use during the operation), perop (to correctly positioning and orienting the medical imaging system selected for the operation) and also in postop with a preop or a postop body 3D model to anticipate the images acquired by a real medical imaging system. Furthermore, it can also be used during the training of the surgeons and the medical staff members.

1-17. (canceled)

18. A computer-implemented method for generating a simulated 2D image of a portion of a patient's body so as to help the planning of a medical intervention on said patient, by means of a graphical user interface comprising a controller configured to control the interaction between a user and the graphical user interface, said medical intervention requiring an acquisition of an effective 2D image during or after said medical intervention, said method comprising:
receiving real 3D medical images of said portion of the patient's body, said real 3D medical images being composed of voxels,
computing a tridimensional digital model of said portion of the patient's body based on said real 3D medical images, by means of a ray tracing algorithm, the reconstructed tridimensional digital model being referred to as body 3D model,
displaying in the graphical user interface a three-dimensional scene comprising said body 3D model computed by means of said ray tracing algorithm, wherein the three-dimensional scene has a corresponding scene coordinate system attached thereto,
computing angular coordinates based on a received position and a received orientation in the scene coordinate system of a selected device, said angular coordinates representing a visualization direction in the scene coordinate system,
generating said simulated 2D image based on said computed angular coordinates by means of a ray-based algorithm comprising sampling the real 3D medical images'voxels along rays whose trajectories depend on said computed angular coordinates,
displaying in a 2D window of the graphical user interface said simulated 2D image.

19. The computer-implemented method according to claim 18, wherein the received position and the received orientation of the selected device are one of:
a current position and orientation of the controller in a predetermined user coordinate system; or
a selected position and selected orientation of a virtual device, said virtual device being previously selected by a user and displayed in said 3D scene with said selected position and said selected orientation.

20. The computer-implemented method according to claim 19, further comprising displaying the simulated 2D image in a display plane positioned in the 3D scene depending on received position and received orientation, the display plane's coordinates changing in the 3D scene in real time, as the user moves the virtual device or the controller in the 3D scene.

21. The computer-implemented method according to claim 20, wherein the 3D body model, and the simulated 2D image displayed in its specific moving display plane, are displayed together in the 3D scene using a stereoscopic display, so as to ease the spatial cognition of the user in relating the content of the simulated 2D image to the representation of the body 3D model.

22. The computer-implemented method according to claim 21, wherein the stereoscopic display is a virtual reality headset.

23. The computer-implemented method according to claim 18, wherein the effective 2D image is one of:
a radiographic 2D image acquired by means of X rays;
an ultrasound 2D image acquired by means of a sonography device; or
an image acquired by a camera placed inside the patient's body.

24. The computer-implemented method according to claim 18 where the real 3D medical images are Computed Tomography (CT) scans, Magnetic Resonance (MR) images or 3D ultrasound images.

25. The computer-implemented method according to claim 18, further comprising, when a visualization criterion is met, recording effective angular coordinates into an external memory, the effective angular coordinates being either equal to the angular coordinates or representative of an orientation, with respect to an interventional coordinate system, of an acquisition device configured to acquire the effective 2D image, the visualization criterion being met when the visualization direction is suitable for the medical intervention on said patient.

26. The computer-implemented method according to claim 18, wherein the acquisition of the effective 2D image is performed during the medical intervention with an interventional 2D imaging device.

27. The computer-implemented method according to claim 26, wherein the interventional 2D imaging device is one of: a C-arm, a G-arm, an endoscope, or a sonography device.

28. The computer-implemented method according to claim 19, wherein the ray-based algorithm generating the simulated 2D image is performed using rays all parallel to the visualization direction as determined by the current position and the current orientation of the controller.

29. The computer-implemented method according to claim 19, wherein the ray-based algorithm generating the simulated 2D image is performed by modeling rays having a predetermined pattern, said predetermined pattern being positioned in the 3D scene using said selected position and selected orientation, and being based on physical characteristics of a real 2D imaging system, possibly comprising specific lenses, filters or collimators, and wherein the rays used by the ray-based algorithms propagates in the 3D scene according to the physics of said real 2D imaging system.

30. The computer-implemented method according to claim 18, wherein the ray-based algorithm generating the simulated 2D image can be configured to render a minimal intensity projection, a maximal intensity projection, or an average intensity projection.

31. The computer-implemented method according to claim 18, wherein the ray-based algorithm generating the simulated 2D image is a ray tracing algorithm.

32. Use of effective angular coordinates recorded with the computer-implemented method according to claim 26 for positioning a C-arm or a G-arm during a medical intervention.

33. Use of a simulated 2D image generated with the computer-implemented method according to claim 18 for planning an implant position in said portion of the patient's body.

34. A device comprising a processor, a graphical user interface comprising a controller configured to control the interaction between a user and the graphical user interface, said processor being configured to carry out the computer-implemented method according to claim 18.

35. A non-transitory program storage device, readable by a computer, tangibly embodying a program of instructions executable by the computer to perform the computer-implemented method of claim 18.
